(19) United States
(12) Patent Application Publication
(10) Pub. No.: US 2011/0223081 A1
(43) Pub. Date: Sep. 15, 2011

(54) Gripper Head for Gripping a Reaction Cuvette

(75) Inventors: Jean-Pierre Teisseire, Pressagny L'Orgueilleux (FR); Dominique Casas, La Garenne-Colombes (FR); Christophe Marcel, Sartrouville (FR)

(73) Assignee: Diagnostica Stago

(21) Appl. No.: 13/036,371

(22) Filed: Feb. 28, 2011

(30) Foreign Application Priority Data
Mar. 11, 2010 (FR) 10/00980

(51) Int. Cl. B01L 9/00

(52) U.S. Cl. 422/561

(57) ABSTRACT

A gripper head for gripping a reaction cuvette in an appliance for automatically analyzing chemical or biological samples, the head comprising pivoting fingers designed to engage lugs that extend from two opposite sides of the top end of the cuvette, an electromagnetic or pneumatic actuator for controlling pivoting of the fingers in one direction, and return springs urging the fingers to pivot in the opposite direction.

### FIELD OF THE INVENTION

The invention relates to a gripper head for griping a reaction cuvette, in particular in an appliance for analyzing chemical or biological samples, the cuvette having two handling lugs extending from two opposite sides of its open top end.

The analysis appliances in which such cuvettes are used include gripper devices for gripping the cuvettes and moving them to various points, e.g. to take them into an incubator and then into a measurement zone and finally into a container for storing them prior to destruction. The gripper devices presently in use are of the pneumatic suction type and they include suction cups that need to be placed on pegs provided on the lugs that are formed at the top ends of the cuvettes.

When the suction cups of a gripper device are connected to pneumatic suction, the cuvette is held firmly by the device and may be safely transported from one point to another in the appliance.

Nevertheless, it is necessary for the suction cups to be accurately positioned on the pegs of the cuvette, and that does not always happen, since no means are provided for ensuring the gripper device is accurately positioned on the cuvette.

The use of pneumatic suction and suction cups, which run the risk of wearing out more or less quickly, also complicates such gripper devices and reduces their reliability and their lifetime.

### BACKGROUND OF THE INVENTION

Document WO 2007/039524 discloses a device for gripping a tube in an appliance for treating biological samples, the device having two fingers pivoting about parallel horizontal axes and designed to be engaged under an annular rim at the top end of the tube in order to grip it and center it automatically. Such a device is usable only with cylindrical tubes having an annular rim in their top portions.

### OBJECT AND SUMMARY OF THE INVENTION

A particular object of the invention is to provide a solution to the above-mentioned problems of the prior art that is simple, effective, and inexpensive.

To this end, the invention provides a gripper head for gripping a reaction cuvette for an appliance for analyzing samples, in particular chemical or biological samples, the head comprising at least two fingers pivotally mounted about parallel horizontal axes, control means for causing each finger to pivot in one direction about its axis, and return means urging each finger to pivot in the opposite direction, the fingers being designed, when they are moved in pivoting towards one another about their axes, to grip the cuvette and to center it automatically relative to the gripper head, wherein the cuvette has two handling lugs extending from two opposite sides of its top ends, the above-mentioned fingers and/or the lugs including co-operating faces that are inclined relative to the movement direction of the fingers, and co-operating faces that are inclined relative to the horizontal, serving respectively to grip the lugs of the cuvette between the fingers and to lift the cuvette when the fingers are moved in pivoting towards one another.

The gripper head of the invention is purely mechanical and, by means of its pivoting fingers, it makes it possible firstly to grip a cuvette and secondly to center it automatically on the gripper head. The cuvette can then be positioned accurately on the analysis appliance by the gripper head, and it is freed from the gripper head and put down on the appliance merely by pivoting the fingers in the opposite direction to the direction in which they were pivoted in order to grip the cuvette.

These operations of gripping and releasing a cuvette can be performed without jolting or shaking, thereby avoiding any risk of contaminating the environment of the cuvette.

When the fingers are moved in pivoting in order to grip a cuvette, they are not only pressed against the lugs of the cuvette in order to center it relative to the gripper head, but they also lift the cuvette a little so as to take it off its support and allow the cuvette to be separated cleanly and without effort from its support. By means of the above-mentioned inclined co-operating faces, it suffices to slide the fingers over the side faces of the lugs of the cuvette in order to lift the cuvette a little at the same time as it is being centered on the gripper device.

In a first embodiment, the gripper head comprises two pairs of pivoting fingers, the fingers of each pair being mounted to pivot about a common horizontal axis and each of them co-operating with a respective side face of a lug of the cuvette.

In a variant embodiment, the gripper head comprises two fingers each designed to co-operate with one lug of the cuvette, the lug including a V-shaped cutout flaring outwards from the cuvette, in order to center the cuvette when the corresponding finger is engaged in the V-shaped cutout.

Advantageously, each above-mentioned finger includes an engagement groove or constriction for engaging the edge of a lug of the cuvette, when the finger is taken to its cuvette-gripping position.

This ensures that the cuvette is held securely by the gripper head, since the cuvette cannot move vertically upwards or downwards relative to the gripper head.

According to other characteristics of the invention:

the finger-pivoting control means comprise a pneumatic or electromagnetic actuator acting on a pusher that is guided to move in translation between cam surfaces or inclined ramps secured to the fingers;

the means for returning the fingers comprise springs mounted on the gripper head;

the gripper head includes centering means for centering on a support for the cuvette in the analysis appliance;

the gripper head includes at least one abutment limiting the downward movement of the head on a support for the cuvette in the analysis appliance; and

the gripper head includes at least a movable finger for detecting the presence of a cuvette and for detecting that it has been gripped.

The invention also provides a reaction cuvette for use in an analysis appliance fitted with a gripper head of the above-described type, wherein the cuvette includes two outwardly-extending lugs on its top end, extending in the plane of the top end of the cuvette, each lug including inclined faces for co-operating with the fingers of the gripper head.

Advantageously, the faces of the lugs of the cuvette are inclined relative to a longitudinal midplane of the cuvette and relative to a horizontal plane.

### BRIEF DESCRIPTION OF THE DRAWINGS

The invention can be better understood and other characteristics, details, and advantages thereof appear more clearly on reading the following description made by way of example with reference to the accompanying drawings, in which:

FIG. 1 is a diagrammatic perspective view of a cuvette gripper head of the invention;

FIG. 2 is a fragmentary face view showing the gripper head approaching a cuvette;

FIG. 3 is a view from beneath corresponding to FIG. 2;

FIG. 4 is a fragmentary face view showing a cuvette gripped by the gripper head;

FIG. 5 is a view from beneath corresponding to FIG. 4;

FIG. 6 is a fragmentary diagrammatic view on a larger scale showing a lug of a cuvette of the invention;

FIGS. 7a and 7b show two steps in gripping a cuvette;

FIG. 8 is a fragmentary diagrammatic view in perspective of a variant embodiment of the invention; and

FIG. 9 is a diagrammatic view in perspective of a reaction cuvette for use with the FIG. 8 gripper head.

### MORE DETAILED DESCRIPTION

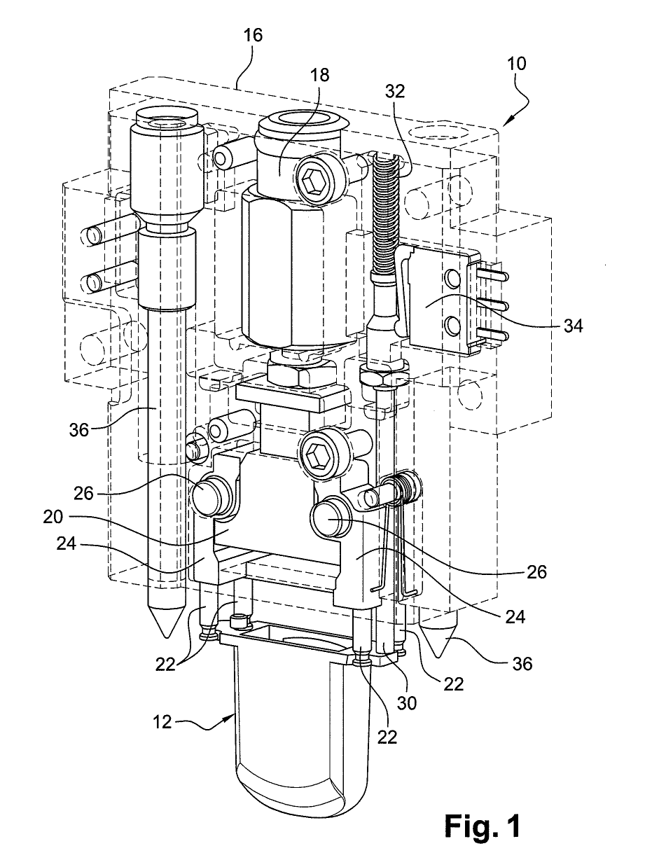

Reference is made initially to FIGS. 1 to 6 that show a first embodiment of the invention, in which a gripper head 10 is movably mounted to move vertically above a reaction cuvette 12 carried by a support, in order to grip the cuvette 12 placed on the support, to lift it above the support, and to move it to another zone, in particular in an appliance for automatically analyzing chemical or biological samples.

The cuvette 12 is of conventional type and is typically made of an injection-molded plastics material. At its open end, it has two lateral lugs 14 for manipulation purposes, which lugs extend outwards in the plane of the top end of the cuvette and are connected to the short side faces of the cuvette.

The gripper head 10 comprises a vertical plate 16 having fastened thereto a pneumatic or electromagnetic actuator 18 that acts on a pusher 20 guided to move vertically along the plate 16 between two pairs of substantially-vertical pivoting fingers 22 having their bottom ends designed to co-operate with the lugs 14 of the cuvette in order to grip it.

Each pair of fingers 22 is carried by a part 24 that is pivotally mounted about a horizontal axis 26 carried by the plate 16, the two axes 26 of the two pairs of fingers 22 being parallel and perpendicular to the plate 16 and to the direction in which the lugs 14 of the cuvette 12 extend.

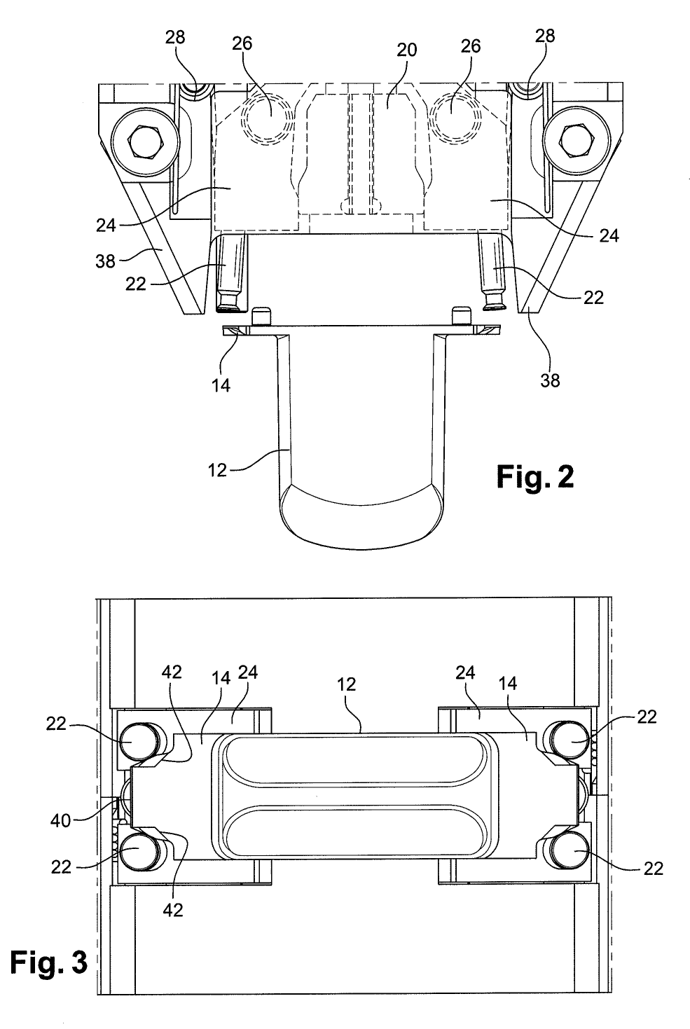

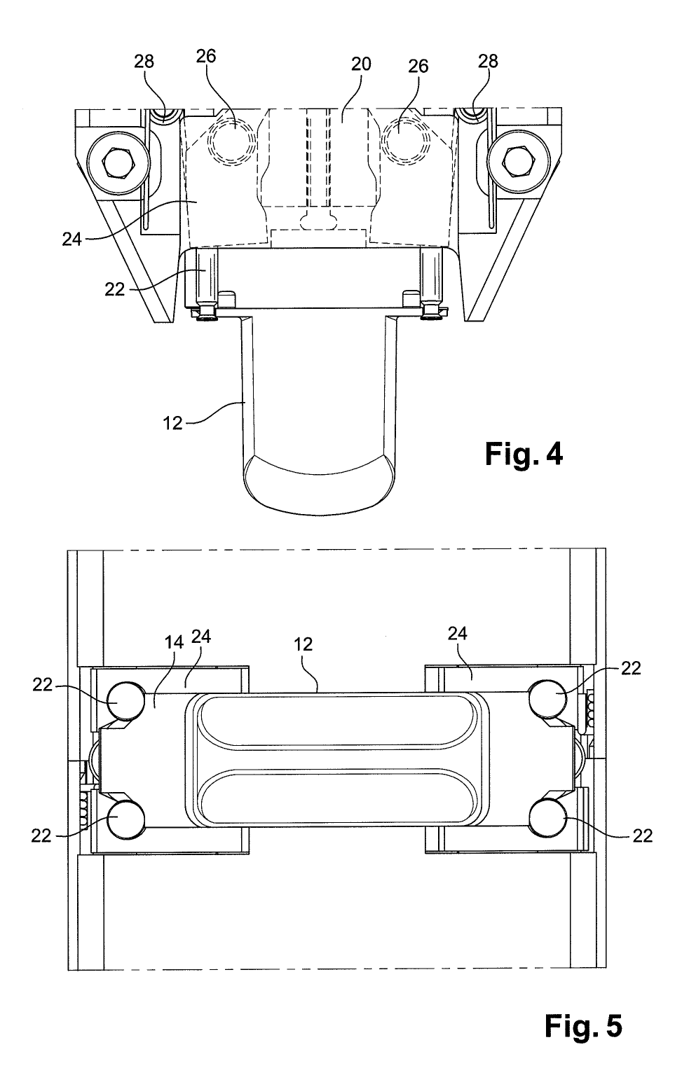

The parts 24 are held pressed against the pusher 20 by springs 28 mounted on the plate 16, one end of each spring pressing against a stationary portion of the head 10 and its other end pressing against a part 24. The contacting surfaces of the parts 24 and of the pusher 20 include inclined ramps acting as cams, such that when the pusher 20 is in a low position as shown in FIG. 2, the two parts 24 and the pairs of fingers 22 carried thereby are spaced apart from one another, the fingers 22 being slightly oblique relative to the vertical, as shown in FIG. 2, whereas when the pusher 20 is in a high position as shown in FIG. 4, the parts 24 are moved towards one another by pivoting about the axes 26, and the fingers 22 are substantially vertical.

The gripper head also includes at least one vertical finger 30 slidably guided over the plate 16 and having its bottom end designed to press against a lug 14 of the cuvette 12, between two of the above-mentioned fingers 22. This slidable finger 30 is urged downwards by a spring 32 and it is associated with detector means 34 for detecting its vertical position, thus making it possible to determine whether the cuvette has or has not been gripped by the gripper head, it being possible for the detector means to be of any suitable type, e.g. inductive or optical or involving electrical contact.

The plate 16 and the head 10 also carry two vertical rods 36 disposed on a diagonal relative to the top end of a cuvette 12, these rods 36 serving to position the head 10 accurately over a support of the cuvette 12, the support forming a reference bearing surface.

The gripper head of the invention is used as follows.

Firstly it is positioned vertically above a cuvette 12 for gripping that is carried by a support (not shown), and then it is lowered vertically towards the cuvette 12, this downward movement being limited by one or more projections 38 carried by the plate 16 (FIG. 2) that come into abutment against the reference bearing surface formed by the cuvette support.

In this lowered position, the parts 24 carrying the pairs of fingers 22 are spaced apart from each other by the pusher 20 that has been moved into a low position by the actuator 18.

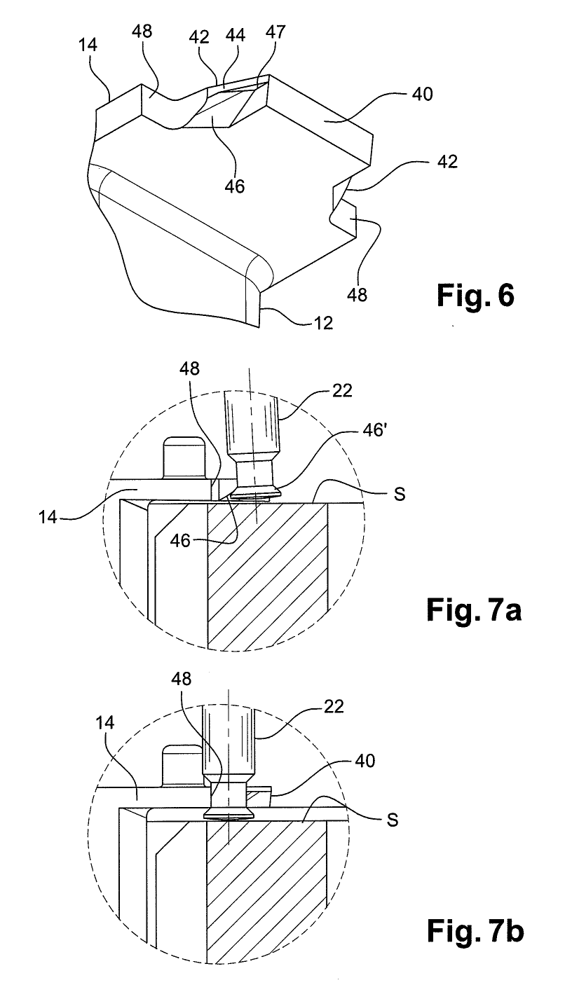

As can be seen in the view from beneath of FIG. 3, the bottom ends of the fingers 22 are then located on either side of the ends 40 of the lugs 14 of the cuvette, these ends 40 being narrower and being connected to the side faces of the lugs 14 by oblique faces 42 serving to center the cuvette relative to the gripper head, the shapes of these oblique faces being more clearly visible in FIG. 6.

At the end of the lowering the gripper head 10, as determined by the projections 38 coming into abutment against the support of the cuvette 12, the pusher 20 is raised into a high position (FIG. 4) by the actuator 18, thereby causing the two parts 24 carrying the pairs of fingers 22 to pivot towards each other, these parts being urged in this direction by the return springs 28.

The fingers 22 are thus brought into a substantially vertical position and slide on the inclined faces 42 of the lugs 14 of the cuvette 12.

These inclined faces 42 have horizontal first portions 44 (FIG. 6) that are inclined relative to a longitudinal midplane of the cuvette and that serve to center the cuvette 12 in a horizontal plane between the four fingers 22, and a second portion 46 that is oblique relative to a horizontal plane, each oblique portion 46 extending as far as the bottom face of a lug 14, as can be seen in FIG. 6.

Each oblique face 46 is approximately triangular in shape and it is connected to the narrow end 40 of the lug 14 at a point 47 situated above the horizontal bottom face of the lug 14.

Thus, when a rim of the bottom end of a finger 22 comes to bear against said oblique face 46 and moves therealong from the position shown in FIG. 3 to the position shown in FIG. 5, that gives rise to the cuvette 12 being raised a little relative to the reference bearing surface formed by its support means.

The bottom ends of the fingers 22 may include inclined faces that are complementary to the inclined faces 44, 46 of the lugs 14 of a cuvette, these inclined faces being formed on an annular rim of the bottom end of each finger 22.

At their ends opposite to the narrow end 40 of each lug, the inclined faces 44, 46 of the lugs 14 are connected to transverse shoulders 48 that limit the pivoting of the pairs of fingers 22 towards each other and on which the bottom ends of the fingers 22 come to bear, as shown in FIG. 5.

In this position, the cuvette 12 is held firmly by the fingers 22 and cannot escape therefrom, neither upwards, nor downwards, nor in a horizontal plane.

Furthermore, the position of the sliding finger 30 provides information about the presence of a cuvette 12 and also about the gripping of the cuvette by the head 10. When the head 10 is fitted with two parallel slidable fingers 30, each bearing against a respective lug 14 of the cuvette 12, detecting the positions of these fingers makes it possible to verify that the cuvette is horizontal.

In order to put the cuvette 12 down in a determined location, the same operations as those described above are performed in the opposite order, i.e. the head 10 is lowered above the location for the cuvette and it is positioned accurately over said location by the rods 36 and by the projections 38, after which the actuator 18 is controlled to lower the pusher 20 into its position as shown in FIG. 2 and to splay the parts 24 apart from each other, thereby having the effect of disengaging the ends of the fingers 22 from the lugs 14 of the cuvette, the fingers 22 being returned to the position shown in FIG. 3, thereby releasing the cuvette.

This release takes place without shaking and without jolting, with the outward pivoting of the fingers 22 giving rise to the cuvette 12 moving down a very small distance into its housing, this downward movement taking place progressively as the fingers 22 slide over the oblique faces 46 of the lugs 14 of the cuvette.

The lifting of the cuvette 12 by the fingers 22 is shown more clearly in FIGS. 7a and 7b.

In FIG. 7a, it can be seen that the annular rim of the bottom end of the finger 22 includes a frustoconical top face 46′ that is complementary to the inclined face 46 of the lug of the cuvette and that is pressed against said face 46 when the finger 22 is brought into contact with the lug 14. In this position, the cuvette rests on a support S and vertical clearance between the top face of the support S and the bottom face of the lug 14 is zero or substantially zero.

In FIG. 7b, the finger 22 has pivoted and is pressed against the shoulder 48 of the lug 14. The inclined face 46′ of the finger 22 has slid over the inclined face 46 of the lug 14 and the annular rim of the bottom end of the finger 22 is engaged under the lug 14 that has been lifted above the support 14 and that is spaced apart therefrom by about 0.4 millimeters (mm), for example.

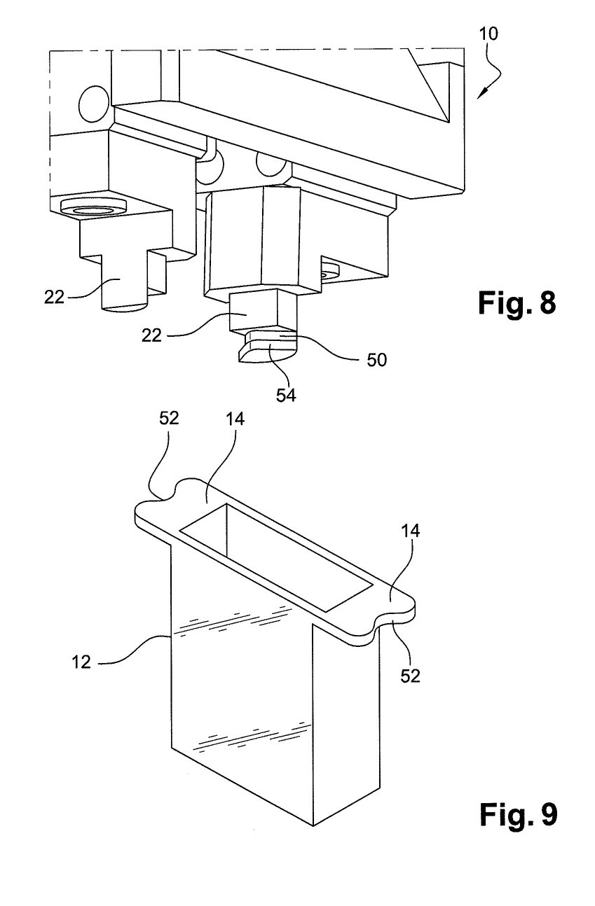

In the variant embodiment of FIGS. 8 and 9, the gripper head 10 has only two pivoting fingers 22 having bottom ends 50 presenting a section that is triangular in shape with the apexes of the triangular shape pointing towards each other.

These ends of the fingers 22 are complementary to notches or cutouts 52 formed in the ends of the lugs 14 of a cuvette 12.

Rims 54 are formed at the bottom ends of the fingers 22 and are designed to be engaged under the lugs of the cuvette in order to support it.

Complementary inclined faces may be formed on the co-operating surfaces of the rims 54 of the ends of the fingers 22 and of the notches 52 in the lugs 14, as described above, and in such a manner that pivoting the fingers 22 towards each other on the gripper head 10 gives rise to the cuvette 12 being centered in a horizontal plane on the gripper head 10, and to the cuvette 12 being lifted a little.

What is claimed is:

1. A gripper head for gripping a reaction cuvette for an appliance for analyzing chemical or biological samples, the head comprising at least two fingers pivotally mounted about parallel horizontal axes, control means for causing each finger to pivot in one direction about its axis, and return means urging each finger to pivot in the opposite direction, the fingers being designed, when they are moved in pivoting towards one another, to grip the cuvette and to center it automatically relative to the gripper head, wherein the cuvette has handling lugs extending from two opposite sides of its top ends, the fingers and/or the lugs including co-operating faces that are inclined relative to the movement direction of the fingers, and co-operating faces that are inclined relative to the horizontal, serving respectively to grip the lugs of the cuvette between the fingers and to lift the cuvette when the fingers are moved in pivoting towards one another.

2. A head according to claim 1, comprising two pairs of pivoting fingers, the fingers of each pair being mounted to pivot about a common horizontal axis and each of them co-operating with a respective side face of a lug.

3. A head according to claim 1, comprising two fingers each designed to co-operate with one lug of the cuvette, the lug including a V-shaped cutout flaring outwards from the cuvette, in order to center the cuvette when the corresponding finger is engaged in the V-shaped cutout.

4. A head according to claim 1, wherein each finger includes an engagement groove or constriction for engaging the edge of a lug of the cuvette, when the finger is taken to its cuvette-gripping position.

5. A head according to claim 1, wherein the finger-pivoting control means comprise a pneumatic or electromagnetic actuator acting on a pusher that is guided to move in translation between cam surfaces or oblique ramps secured to the fingers.

6. A head according to claim 1, wherein the means for returning the fingers comprise springs.

7. A head according to claim 1, including centering means for centering on a support for the cuvette in the analysis appliance.

8. A head according to claim 1, including at least one abutment limiting the downward movement of the head on a support for the cuvette in the analysis appliance.

9. A head according to claim 1, including a movable finger for detecting the presence of a cuvette and for detecting that it has been gripped.

10. A reaction cuvette for use in an analysis appliance fitted with a gripper head according to claim 1, wherein the cuvette includes two outwardly-extending lugs on its top end, extending from two opposite sides of the top end of the cuvette, each lug including inclined faces for co-operating with the fingers of the gripper head.

11. A cuvette according to claim 10, wherein said faces of the lugs are inclined relative to a longitudinal midplane of the cuvette and relative to a horizontal plane.
